(19) United States
(12) Patent Application Publication
(10) Pub. No.: US 2011/0035294 A1
(43) Pub. Date: Feb. 10, 2011

(54) MULTI-TIER TRANSACTION PROCESSING METHOD AND PAYMENT SYSTEM IN M- AND E- COMMERCE

(75) Inventor: LEN L. MIZRAH, San Carlos, CA (US)

Correspondence Address: HAYNES BEFFEL & WOLFELD LLP, P O BOX 366, HALF MOON BAY, CA, 94019, US

(73) Assignee: Authernative, Inc., Redwood City, CA (US)

(21) Appl. No.: 12/535,546

(22) Filed: Aug. 4, 2009

(51) Int. Cl. G06Q 30/00; G06Q 10/00; G06F 21/00

(52) U.S. Cl. 705/26.42; 705/80; 705/30; 726/4

(57) ABSTRACT

A server executes a protocol that automates transactions involving a customer and a merchant agreeing to trade money in the customer's account for goods or services available from the merchant. The protocol protects personal identifying information of the customer from disclosure to the merchant, and protects all parties from repudiation of the specific transaction. The protocol defines a pre-authenticated form of the specific transaction; obtains authorization from the customer and the merchant to commit on their behalf to the pre-authenticated transaction; and obtains authorization from the bank to commit resources for settlement with the merchant. After obtaining authorizations, a transaction clearance code is generated completing a record of the pre-authenticated transaction for non-repudiation, for proof of a right to receive settlement from the third party and for proof of a right to receive the goods or services from the merchant.

### BACKGROUND OF THE INVENTION

1. Field of the Invention

The invention generally relates to electronic commerce (e-commerce) and mobile commerce (m-commerce) electronic systems, their computer networking architecture, and more specifically to a multi-tier transaction processing method and payment system for parties to a transaction.

2. Description of Prior Art

Trade conducted electronically via communication networks is the foundation of the contemporary economy. The advancements in computer networks have enabled highly efficient electronic funds transfer, Internet marketing, electronic data interchange, supply chain management, inventory management, and a number of other processes. Two basic types of transaction networks are referred to as business-to-business (B2B) or business-to-consumers (B2C) networks. During the last decade, with advancements in B2B and B2C e-commerce, there have been significant attempts to establish new transaction processing architectures and payment systems. A rapid penetration of wireless communication into the world's social and business fabric has spurred m-commerce development as an important complement to e-commerce. One definition of m-commerce is as follows: “Mobile Commerce is any transaction, involving the transfer of ownership or rights to use goods and services, which is initiated and/or completed by using mobile access to computer-mediated networks with the help of an electronic device.” (see http://en.wikipedia.org/wiki/Mobile_commerce)

The technological field attempting to deploy a single buy/sell transaction processing architecture in e- and m-commerce has become quite complex and highly competitive due to a significant flexibility provided by advances in the computer networking technologies, and to an enormous importance attributed by a variety of business and consumer interests to any practically implemented change in payment systems. There are market drivers that help in shaping and analyzing the progress in this field.

Standard credit/debit card payment systems have well known security and privacy issues that hamper and hinder e- and m-commerce, deterring masses from B2B and B2C transactions. Thus, there is a substantial need for innovative technologies to improve remote trust, cyber-security and privacy of transacting parties, while reducing payment fraud, identity theft, and phishing attacks.

The weaknesses in deployed and practiced online and offline payment solutions have arisen due to insufficient attention to thorough design and implementation of proper authentication, authorization, and accounting processes for parties to a transaction. There is a need for improvements in e- and m-commerce payment solutions that would support non-repudiation of parties to a transaction, help to filter out identity theft and cyber-attacks, and change the mass perception of weak security and privacy in such systems.

One of the important issues to resolve is unification and standardization of various payment methods and associated customer experiences. Currently, there are different payment techniques for a customer online vs. customer offline, a customer-at-rest vs. customer-on-the-move, and an m-commerce customer vs. e-commerce customer. It would be desirable to improve usability of customers' payment solutions and to standardize back offices' transaction processing technology in order to lure more transactions and to reduce the actual transaction cost.

Representative prior art e- and m-commerce payment methods and transaction-processing technologies are described in Gupta, U.S. Pat. No. 7,324,976; Gupta, U.S. Pat. No. 7,383,231; Caplan, U.S. Pat. No. 7,542,943; Grinberg, WO2004114168; Elgamal, U.S. Pat. No. 6,138,107; Marsh, U.S. Pat. No. 7,552,365; Barsade, U.S. Pat. No. 7,562,033; Barnes, U.S. Pat. No. 7,487,112; Bansal, U.S. Pat. No. 7,483,857; Li, U.S. Pat. No. 7,457,778; Barsade, U.S. Pat. No. 7,398,239; Dunn, U.S. Pat. No. 6,701,303; Wang, U.S. Pat. No. 6,618,705; Kolls, U.S. Pat. No. 6,606,602; Kolls, U.S. Pat. No. 6,601,039; Kolls, U.S. Pat. No. 6,601,037; Li, U.S. Pat. No. 7,457,778; Lovell, US 2008/0182551; Waltman, US 2007/0215687; Hung-Che Chiu, U.S. Pat. No. 6,937,731; Singh, US 2007/0100710; Pegaz-Paquet, U.S. Pat. No. 7,177,837; Petrovich, U.S. Pat. No. 7,155,405; Singh, US 2007/0174082; Janacek, US 2005/0286421; Keech, US 2003/0191945; Woo, US 2003/0154139; Melick, U.S. Pat. No. 7,350,708; Stolfo, U.S. Pat. No. 7,069,249; McCann, US 2001/0046856.

Also, earlier work of the present inventor in this field is described in U.S. Pat. No. 7,379,916 entitled SYSTEM AND METHOD FOR PRIVATE SECURE FINANCIAL TRANSACTIONS, invented by Mizrah.

It is desirable to provide a unifying transaction architecture for automating transactions between consumers and merchants that does not expose a consumer's personal identifying information to merchants, that eliminates repudiation of the transactions, that can be executed by a consumer using a mobile terminal such as a cell phone or a stationary terminal such as a personal computer, and that is easy to learn and use.

### SUMMARY OF THE INVENTION

A method and a system are described for automated transactions based on a server-implemented protocol. The protocol mediates automated transactions involving a consumer as a first party and a merchant as a second party in which the first party agrees to pay a specific amount of money, or trade other resources, from an account held by a third party such as a bank, a mobile network operator, credit card company or other customer account holding entity, in exchange for goods or services provided by the second party. The protocol protects personal identifying information of the first party from disclosure to the second party, while protecting the specific transaction from repudiation by any party to the transaction.

An automated transaction method as described herein comprises executing a protocol using a server for obtaining commitments from the first, second and third parties to a specific transaction in which transaction parameters are arranged between the first and second parties. The protocol defines a pre-authenticated form of the specific transaction, obtains authorization from the first and second parties for the server to commit on behalf of the first and second parties to the specific transaction in the pre-authenticated form, and obtains authorization from the third-party for the server to commit, on behalf of a third-party, resources for settlement of the specific transaction in the pre-authenticated form with the second party. After obtaining authorizations from all three parties, the server generates a one-time transaction clearance code unique to the specific transaction. The transaction clearance code is delivered to the parties. The transaction clearance code is usable by the second party to prove a right to receive resources to settle the transaction from the third party. The transaction clearance code is also usable by the first party to prove a right to receive the goods or services specified in the pre-authenticated transaction from the second party. A record of the transaction is maintained by the server, usable to prevent repudiation of the transaction by any party. Under this protocol, the second party need not receive any personal identifying information about the first party, while being able to execute a transaction which cannot be repudiated by the first party or by its bank.

An exchange of messages to define the pre-authenticated form of a specific transaction as described herein includes exchanges of messages on communication channels between the server and terminals of the first and second party, and uses a multi-tier procedure. In a first tier, the exchange of messages provides for authentication of the first party to the server by a user authentication process that identifies the first party and verifies that the first party holds an account with a third party. In a second tier, the exchange of messages provides for identification and verification of the transaction parameters by receiving an identifier of the second party from the first party, by communicating with the second party for determination of the transaction parameters, and by communicating with the first party for verification of the transaction parameters. In a third tier, the exchange of messages provides for authentication of the server to the first party by, for example, delivering a transaction parameter determined by the server from the second party and not previously delivered to the server by the first party.

An exchange of messages is described herein for establishing authorization for the pre-authenticated transaction from the first and second parties to commit on behalf of the first and second parties to the specific transaction in the pre-authenticated form. Authorization is achieved by exchanging messages on communication channel between the server and the terminals of the first party and the second party, including communicating with the second party for indication of the authorized transaction parameters and communicating with the first party for verification of the authorized transaction parameters.

In embodiments of the protocol, the server performs a process to facilitate agreement of the transaction parameters for the specific transaction between the first and second party. For example, the server can act to present a catalog of goods or services, such as a menu or Internet-based shopping portal, which is available from a merchant chosen by the first party. The first party utilizes this process to select goods or services, and the second party utilizes this process to communicate authorized transaction parameters based on the selections to the server.

The protocol described herein is operable for customers at stationary terminals and for customers on the move using mobile terminals. Terminals of the first, second and third parties are computing platforms which can be presumed to be under the control of the respective parties. In any one transaction, the protocol may involve establishing variant communication channels using a plurality of terminals presumed to be under the control of any one of the parties, such as a channel to a personal computer and a channel to a mobile smart phone under the control of a customer. However, examples described herein refer to only one terminal per party.

A server having an architecture adapted to execute the protocol described herein is also described. A server is a data processing system including a computer or a number of computers on a computer network and/or bus system, configured with a storage system, communication interfaces and computer programs executed by the computer or computers that on execution by the data processing system provide services in support of automated transactions, as described herein.

Other aspects and advantages of the method and system described herein are set forth below in the figures, the detailed description and the claims.

### BRIEF DESCRIPTION OF THE DRAWINGS

FIG. 1 is a conceptual block diagram of the multi-tier transaction processing method and payment system in m- and e-commerce described herein.

FIG. 2 is a simplified block diagram of a computer system capable of implementing the multi-tier transaction processing method and payment system described herein.

FIG. 3 is a basic flow diagram according to one process described herein for the multi-tier transaction processing method and payment system described herein.

FIG. 4 is a representative flow diagram of the multi-tier transaction processing method and payment system in m- and e-commerce when a customer is at rest (immobile) during an online or offline transaction (the preferred payment architecture embodiment).

FIGS. 5 and 6 present a flow diagram of the multi-tier transaction processing method and payment system in m- and e-commerce when a customer is on-the-move during an online transaction (the preferred payment architecture embodiment of a customer in a car while processing a transaction with a gas station).

FIGS. 7 and 8 present a flow diagram of the multi-tier transaction processing method and payment system in m- and e-commerce when a customer is on-the-move during an online transaction (the preferred payment architecture embodiment of a customer in a car while processing a transaction with a fast food restaurant).

It should be understood that these figures depict embodiments of the invention. Variations of these embodiments will be apparent to persons skilled in the relevant art(s) based on the teachings contained herein.

### DETAILED DESCRIPTION

Network and Information Infrastructure of Parties to a Transaction

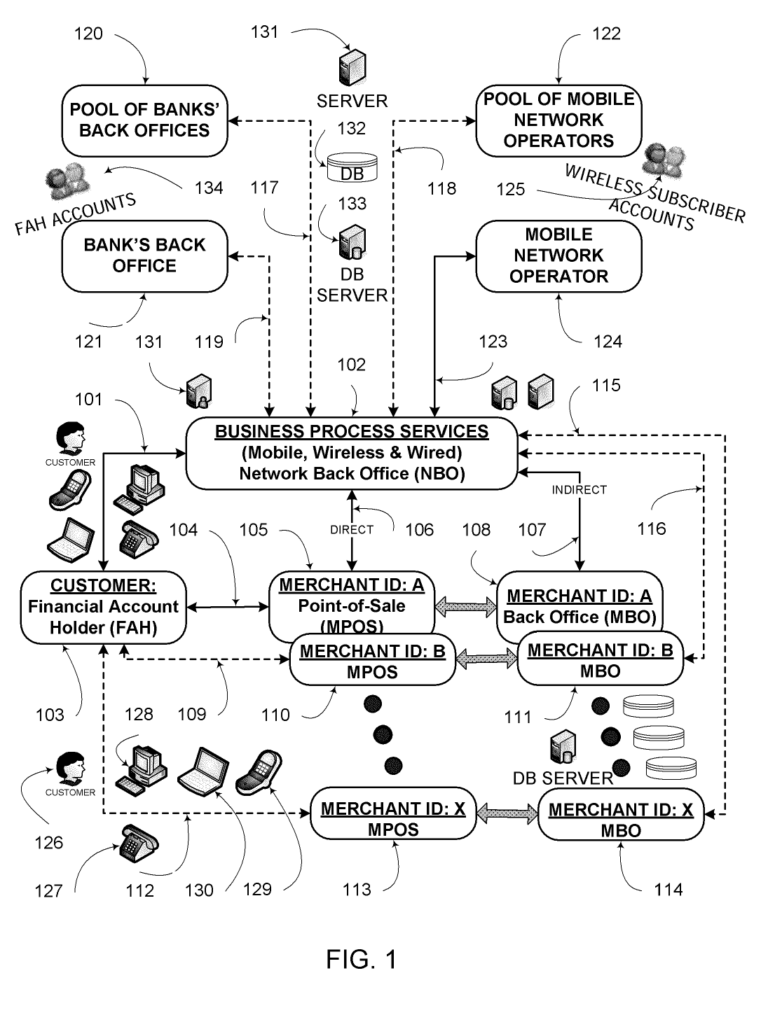

The present invention considers several parties to an offline or online customer's transaction followed by a payment for merchant's products, goods, and/or services. A customer (103, 126 in FIG. 1) is a legitimate person or business having a financial account with a bank or other financial services company (a Financial Account Holder (FAH)). A merchant is one having a Merchant ID and a Merchant Point-of-Sale (MPOS). MPOS can be a physical device inside a brick and mortar shop or a virtual graphical interface to enter transaction parameters when visiting online a merchant's Web site (105, 110, and 113 in FIG. 1).

Typically, a merchant is expected to have a Merchant Back Office (MBO) where transaction parameters like a customer ID, a time stamp(s), a list of goods and/or services, their prices, and other transaction related information are stored and processed for merchant's administration and accounting purposes (108, 111, and 114 in FIG. 1).

Customer account holding entities such as servers in a Bank's Back Office or in a Pool of Banks' Back Offices (121 and 120 in FIG. 1), where FAH accounts are maintained (134, in FIG. 1), are connected (119, 117 in FIG. 1) with a computer system executing business process services in a Network Back Office (NBO) (102 in FIG. 1). Customers (103, 126 in FIG. 1) at customer terminals and the computer system at an NBO (102 in FIG. 1) can be connected (101 in FIG. 1) using mobile, wireless, or wired communication channels (129, 130, 128, 127 and 112 in FIG. 1).

A server at the NBO typically connects to remote terminals at the MPOS, MBO, MNO(s), or Bank(s) Back Office(s) (105, 110, 113, 108, 111, 114, 124, 122, 121, and 120 in FIG. 1) through wireless or wired communication channels (106, 107, 116, 115, 123, 118, 119, and 117 in FIG. 1). As will be discussed below, business processes executed at the NBO play a multifunctional role as a party to a transaction. In addition to, or instead of, account service providers like Bank Back Office(s), other account service providers like a Mobile Network Operator (MNO) or a Pool of Mobile Network Operators (124 or 122 in FIG. 1) can be connected to the server at the NBO.

MNO 124 can be, for instance, a wireless carrier which strictly speaking is not a financial services company. However, it often has millions of wireless subscriber accounts (125 in FIG. 1) and servers which provide services for such account. In various arrangements, the MNO can either obtain a license for financial services or partner with a financial services company or a bank. In either case, wireless subscribers to the MNO 124 are FAHs as well and would be able to participate in the system as described here. Use of credit card based account service providers is also possible.

Customers (103, 126 in FIG. 1) and MPOS (105, 110, or 113 in FIG. 1) can be connected (104 in FIG. 1) using mobile, wireless, or wired communication channels (129, 130, 128, and 112 in FIG. 1).

Typically, processing, storage, and communication power of MPOS, MBO, NBO, MNO(s), and Bank(s) Back Office(s) (105, 110, 113, 108, 111, 114, 102, 124, 122, 121, and 120 in FIG. 1) are enabled with commercial grade servers, databases, database servers, and real time communication servers (131, 132, 133, and 131 in FIG. 1).

Payment Architecture in E- and M-Commerce

FIG. 1 is a block diagram of the multi-tier transaction processing method and payment system in m- and e-commerce. An online or offline customer (FAH, 103, 126) reviews merchant's products, goods, and services and then agrees with a merchant on the scope, value, and price (and maybe on some other transaction related parameters like time to complete transaction, delivery time, product warranty time, service grade, and the like) of the purchasing transaction at MPOS (105, 110, and 113 in FIG. 1).

A merchant enters this information into MPOS and logs it at MBO (108, 111, and 114 in FIG. 1) assigning a certain unique Transaction ID number to this pre-arranged purchasing. Concurrently, MPOS generates a unique one-time Transaction ID number, a total cost in dollars for the purchasing (including appropriate taxes), and a legal Merchant ID number and hands it over to the customer (may be in a pre-sales receipt format) inside a brick and mortar shop or makes it available for an online customer. Practically speaking, the merchant is pre-authorizing the transaction to the customer by providing this required information.

Then, the customer (103 in FIG. 1) connects to NBO (102 in FIG. 1) and requests pre-authentication of the entire transaction by submitting the Transaction ID, the Merchant ID, and positively authenticating oneself as a legitimate FAH. Otherwise, NBO denies and interrupts the transaction. At least a two-factor FAH authentication is preferred according to recognized standards required for security purposes.

The Federal Financial Institutions Examination Council (FFIEC), an interagency governmental body empowered to prescribe standards for the federal examination of financial institutions, announced stricter rules for verifying customers' identities during online banking transactions. The new guidelines, outlined in the document “Authentication in an Internet Banking Environment,” mandated that by Jan. 1, 2007, U.S. banks must have a plan to implement two or more factors of identity authentication in Internet banking and all forms of electronic banking activities.

Following FAH's personal authentication, NBO proceeds with the transaction request by getting connected to the particular Merchant ID MBO (any of 108, 111, or 114 in FIG. 1) and requesting a total cost in dollars for the purchasing (including appropriate taxes) and all other information under the Transaction ID number given by the customer. MBO checks validity of the Transaction ID number and if correct, provides to NBO the required information. Otherwise, MBO denies and interrupts the transaction. Practically speaking, the merchant is pre-authorizing the transaction to NBO by providing that required information.

NBO 102, having obtained this information from the merchant's back office 108, 111, or 114 completes the pre-authentication of the entire transaction, as the authenticity of FAH, Merchant ID and Transaction ID is confirmed by this time. Otherwise, NBO denies and interrupts the transaction.

Then, NBO 102 either continues the session with the customer or it connects to the customer 103, 126 again by transmitting to the customer at the same terminal 103, 126 or a different terminal, a communication carrying the Transaction ID, the Merchant ID and the total cost of the purchasing in dollars (including necessary taxes) and may be some other information obtained from MBO under this particular Transaction ID. The customer verifies the dollar amount and other parameters with the ones having been received in the prior session with the merchant (placed in the pre-sales receipt or saved online at the customer's computer).

If the verification is successful and the customer still desires to proceed with the purchasing, then during the same communication session with the NBO, it obtains a request from the customer to pay for the transaction (the purchasing). Practically speaking, the customer is pre-authorizing the transaction to NBO by providing the payment request.

Then, in turn, NBO begins the accounting session by checking if the amount for the payment is available at the FAH/customer account and if correct, NBO allocates and locks that amount of money on the account for the further settlement with the merchant. Upon allocation of the funds, the NBO has pre-authorization from the financial services company, or other account management entity, for completion of the transaction. That completes the NBO's internal procedure of making a final authorization decision on the purchasing (on the transaction).

Hence, at this moment NBO sends to the merchant, to the customer, and to the bank's (or MNO's) back office the Transaction Clearance Code—a unique one-time alphanumeric code. Then, the online or offline customer submits the Transaction Clearance Code and the Transaction ID to the merchant which completes the purchasing after a positive verification of the numbers. Otherwise, the merchant denies and interrupts the transaction.

There are several important notes outlining some attractive capabilities and features of this technology for customers, merchants, and companies having significant amounts of account holders:
1. Transaction Clearance Code is a non-refutable evidence that all parties to a transaction have pre-authorized the purchasing (a distributed multi-tier pre-authorization) and the entire transaction has been centrally pre-authenticated (including for example the customer's two-factor authentication) by the NBO, and as such can be used for non-repudiation services. It should reduce fraud related merchant losses, chargeback, customers' and merchants' repudiation of transactions.
2. Merchants do not need customers' Personal Identifiable Information (PII) like a driver license, a user ID, an address, a phone number and the like to process transactions (unless the customer voluntarily provides some of such information for products, goods or services delivery, or for some other purposes). Therefore, the purchasing transactions become more private and secure as merchants cannot gather customers' PII for sale or disseminate it due to the leaks at the merchant gateways.
3. In the present invention, the payment architecture does not require any usage of credit or debit cards (though they are easily accommodated if the need arises) to perform purchasing transactions. That alone would allow for a transaction fee mitigation which can reduce merchants' losses to the acquiring banks.
4. The proposed payment architecture does not require any new hardware technology, being implementable using commercial grade, proven, and widely used and tested computer-networking, storage and communication technologies. Actually, placing the center of weight on NBO, MBOs, and Bank Back Offices is in line with a contemporary industry shift towards big data centers.
5. Businesses providing account services for significant numbers of account holders with legal and financial responsibilities can partner with NBO and financial services companies to obtain and take part in a transaction fee revenue stream created by their account holders' purchasing activity and effectively compete with card issuing banks and card brand holders.
6. One of the current problems in the payment industry is variety of often conflicting payment schemes, technologies, user experiences, privacy and security holes. It confuses the customers and precludes a wide spread of any particular payment technology, especially due to the differences in online and offline shopping experience. The payment architecture of the present invention contains this unifying opportunity between online and offline transactions as all the customer's major steps and all the parties to the transaction are essentially the same, while the privacy and security of the transaction is well preserved, as well as other benefits to customers and merchants for both types of transactions.

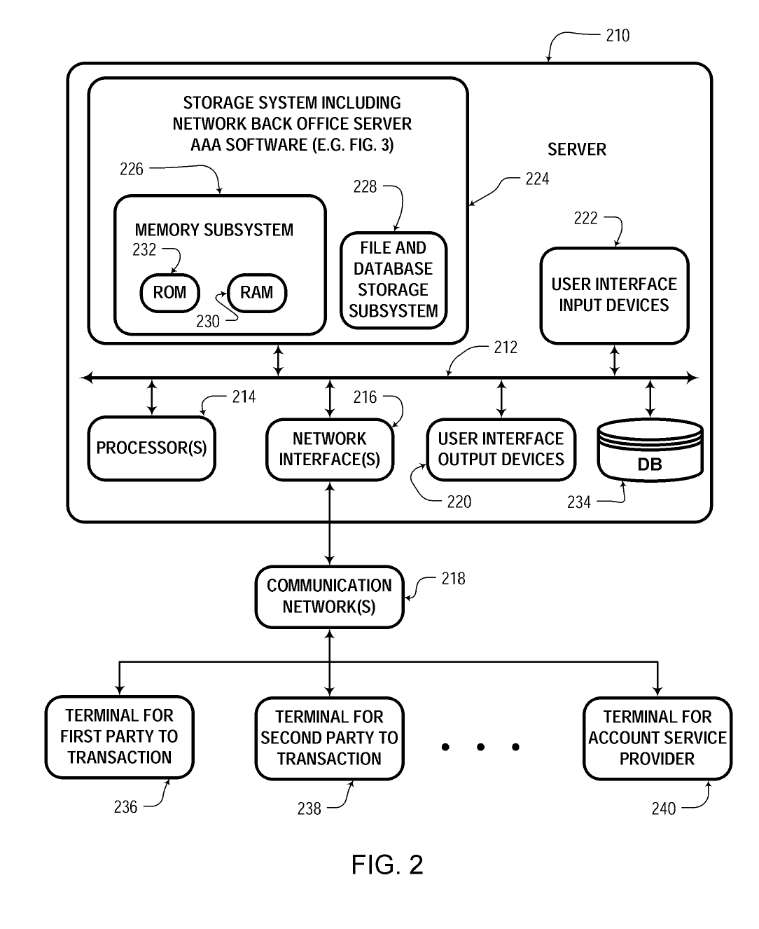

FIG. 2 is a simplified block diagram of a server 210 suitable for implementation of the business process services executed in the NBO. The server 210 could also host other services, including account management for a financial service provider, or merchant back office services for a merchant, for example, if the NBO service was hosted by a financial service provider or a merchant. In contemplated embodiments, the NBO would be an independent server, but is not necessarily so. Server 210 is a computer or set of computers that typically includes at least one processor 214 which communicates with a number of peripheral devices via bus subsystem 212. These peripheral devices may include a storage subsystem 224, comprising a memory subsystem 226 and a file storage subsystem 228, user interface input devices 222, user interface output devices 220, and a network interface subsystem 216. The input and output devices allow user interaction with computer system 210. Network interface subsystem 216 provides an interface to outside networks, including an interface to a communication network or communication networks 218, and is coupled via communication network 218 to corresponding interface devices in other computer systems, including a terminal 236 for a first party to a specific transaction, a terminal 238 for a second party to the specific transaction and a server 240 for an account service provider. Communication network 218 may comprise many interconnected computer systems and communication links. These communication links may be wireline links, optical links, wireless links, or any other mechanisms for communication of information.

User interface input devices 222 may include a keyboard, pointing devices such as a mouse, trackball, touchpad, or graphics tablet, a scanner, a touchscreen incorporated into the display, audio input devices such as voice recognition systems, microphones, and other types of input devices.

User interface output devices 220 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices.

Storage subsystem 224 stores software modules including the basic programming and data constructs that provide the functionality of some or all of the authentication, authorization and accounting AAA processes described herein, including the strong user authentication, transaction pre-authentication, transaction clearance code generation. These software modules are generally executed by a processor or processors 214.

Memory subsystem 226 typically includes a number of memories including a main random access memory (RAM) 230 for storage of instructions and data during program execution and a read only memory (ROM) 232 in which fixed instructions are stored. File and database storage subsystem 228 provides persistent storage for program and data files, and may include a hard disk drive (e.g. mass storage drives 234), a floppy disk drive along with associated removable media, a CD-ROM drive, an optical drive, or removable media cartridges. The databases and modules implementing the functionality of certain embodiments, and records of transactions and parties to transactions can be stored by file and database storage subsystem 228.

Bus subsystem 212 provides a mechanism for letting the various components and subsystems of computer system 210 communicate with each other as intended. Although bus subsystem 212 is shown schematically as a single bus, alternative embodiments of the bus subsystem may use multiple busses or other communication structures supporting distributed processing using networked systems, cloud computing, server farms and other system arrangements.

Computer system 210 can be of varying types including one or more of a personal computer, a portable computer, a workstation, a computer terminal, a network computer, a mainframe, or any other data processing system or user device. The description of computer system 210 depicted in FIG. 2 is intended only as an example for purposes of illustrating the preferred embodiments.

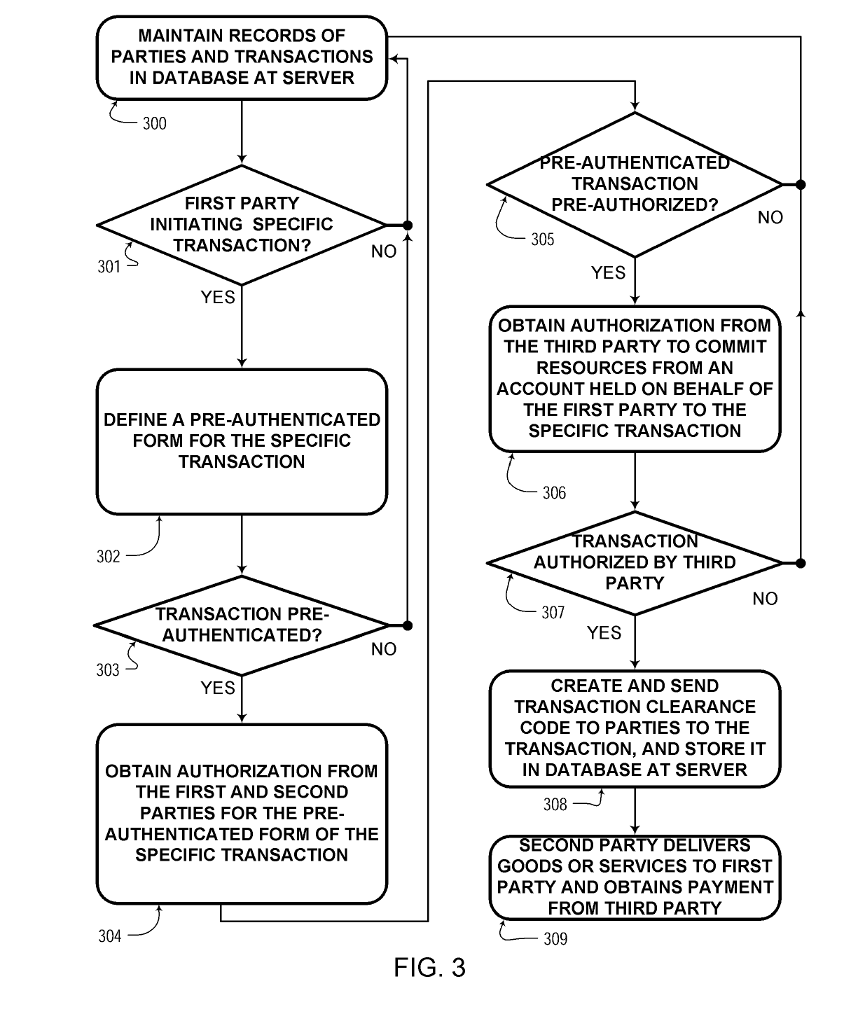

FIG. 3 is a flowchart illustrating a computer program which can be implemented by executable instructions in a server like that described with reference to FIG. 2, for carrying out a basic protocol back office to achieve the multi-tier transaction processing method and payment system described herein. The basic protocol includes maintaining in a database or equivalent memory system records of parties, including merchants, customers and customer account holding entities, which participate in transactions and records of transactions executed by the protocol (300). The server executing the protocol waits for initiation of specific transactions by a first party, typically a customer (301). In the flowchart, the wait-state is represented by the loop from block 301 back to block 300, if there has not been an initiation of a specific transaction. If at block 301, the server receives a message initiating a specific transaction from a first party, it initiates a sequence of messages to define a pre-authenticated form for the specific transaction that includes multiple tiers of authentication (302). The protocol authenticates the first party, identifying the first party and verifying that the first party owns an account with a particular customer account holding entity, where the customer account holding entity is referred to as the third party herein. The authentication of the first party can be accomplished using a user authentication protocol in cooperation with a designated third-party for the first party, in which the server executing the protocol can act as a proxy for the third-party in the authentication protocol or otherwise directly engage an authentication server for the third-party. As discussed above, strong authentication protocols are preferred, and required in some jurisdictions. The protocol also authenticates the specific transaction, by an exchange of messages between the server and the first party and the second party, wherein the second party is typically the merchant, to identify and verify transaction parameters of the specific transaction. The protocol also authenticates the server to the first party, such as by sending a message to the first party carrying a transaction parameter learned from the second party. Upon a response message from the first party indicating confirmation of the transaction parameter, the protocol has defined a specific transaction in a pre-authenticated form after multiple tiers of authentication. The protocol stores the pre-authenticated form of the specific transaction in a record for the specific transaction in the server.

As indicated, the protocol determines whether the transaction has been successfully pre-authenticated (303). If not, the transaction is stopped, and the server returns to the wait state. If the protocol successfully pre-authenticates the specific transaction, then it also obtains authorization from the first and second parties for the server to commit on their behalf to the specific transaction in its pre-authenticated form (304). These authorizations can be obtained by the same sequence of messages used for establishing the pre-authenticated form of the transaction. Thus, a message from the second party carrying transaction parameters to the server that not only serves to define the pre-authenticated form of the transaction, but also serves as an indication that the second party has authorized the server to commit to that transaction on its behalf. Also, a message from the first party indicating confirmation of a transaction parameter received from the server that authenticates the server to the first party, can also serve as an indication that the first party has authorized the server to commit to the pre-authenticated form of the specific transaction on its behalf.

The protocol determines whether the pre-authenticated transaction has been successfully pre-authorized by the first and second parties (305). If not, then the transaction is stopped and the server returns to the wait state. If the pre-authenticated transaction has been pre-authorized, then the server stores a pre-authorization indication in the record for the specific transaction at the server, and executes an exchange of messages with the third party to obtain authorization to commit resources to the specific transaction (306). This third party authorization can be obtained by an exchange of messages with the third party delivering transaction parameters that enable the third party to verify that the first party has sufficient resources to satisfy the parameters of the pre-authenticated transaction, and then to allocate such resources for later settlement with the second party.

The protocol determines whether the pre-authenticated transaction has been authorized by the third-party (307). If it has not, then the transaction is stopped, and the protocol returns to the wait state. If the transaction has been authorized by the third-party, then the server stores an indication of authorization by the third party in the record of the specific transaction at the server. At this point, the server has obtained both authentication of the transaction and authorization to commit to the transaction on behalf of all the parties. The protocol then generates and sends a transaction clearance code to all three parties of the transaction, and stores the transaction clearance code and a record of the specific transaction at the server (308). This embodiment of the protocol is complete from the point of view of the server at this stage.

The transaction clearance code becomes proof of the transaction usable among the parties of the specific transaction in its pre-authenticated form. Upon presentation of the transaction clearance code by the first party to the second party, the second party is obligated to deliver the goods or services defined by the pre-authenticated transaction. Upon presentation of the transaction clearance code by the second party to the third party, the third party is obligated to deliver the resources allocated for settlement of the account to the second party (309). The transaction clearance code and the record of the specific transaction held by the server become evidence sufficient for use for non-repudiation of the specific transaction by the first, second and third parties.

E- and M-Commerce Transaction Data Flow When Customers Are at Rest (Immobile)

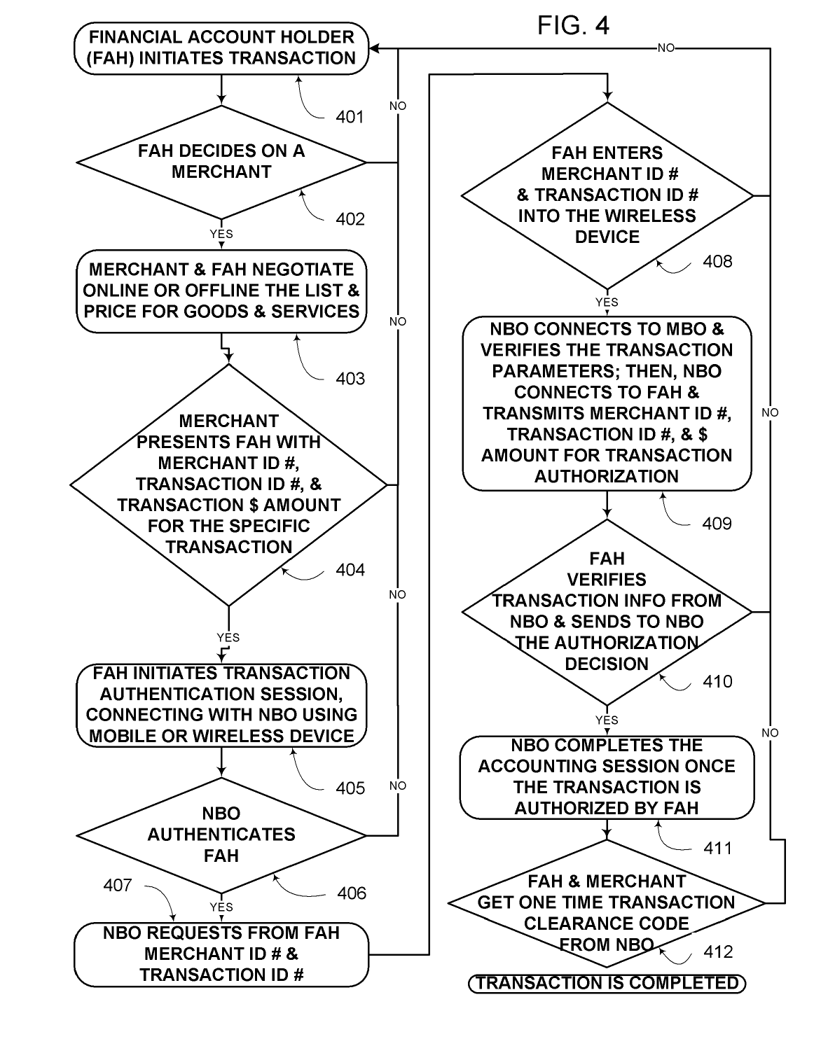

FIG. 4 is a flow diagram of the multi-tier transaction processing method and payment system in m- and e-commerce when a customer is at rest (immobile) during online or offline transaction (the preferred payment architecture embodiment). Let's consider the data flow in FIG. 4:
1. Account holder initiates a transaction (401).
2. Account holder enters the merchant location online or offline and makes a purchase decision (402).
3. Merchant upon receiving the order, verbally or online, from the account holder enters the transaction data into the POS terminal within the merchant's location (403).
4. Merchant POS assigns a unique transaction ID number to that specific sale and it is put into queue within the merchant back office (MBO) for retrieval. Then, merchant provides the account holder with the business's Merchant ID number, the unique transaction ID number that was assigned by the POS for the specific intended transaction for the goods and/or services ordered by the account holder (404).
5. Account holder then requests an m-commerce or e-commerce transaction from the server at the NBO server (405).
6. Account holder, using a mobile or wireless device for example, first participates in an authentication process with the NBO server to securely identify him/herself to the NBO server (406).
7. NBO server requests that the account holder enter the merchant ID number, and the unique transaction ID number. The NBO server specifically DOES NOT request the financial amount of the transaction from the account holder (407, 408).
8. The NBO server then, utilizing the merchant ID number and the unique transaction ID number, requests from the server at a merchant back office MBO the financial transaction parameters associated with the unique transaction ID number (e.g., time stamp, specific location, and the financial amount of the purchase) (409).
9. The MBO server provides the NBO server with the transaction details, time stamp, location, and financial amount of the purchase (409). This serves as pre-authorization by the MBO to the NBO. This also completes the pre-authentication of the transaction by identification and verification of the parameters of the transaction.
10. The NBO server sends the unique transaction data that has been requested by the NBO server from the MBO server to the account holder for verification (409). Also, this effectively pre-authenticates the NBO server to the account holder.
11. Account holder is then required by the NBO to verify the Merchant ID number and specific location, time stamp, and the financial transaction amount. By having the NBO submit to the account holder the financial transaction amount for specific verification by the account holder, it creates a non-repudiating event for both the account holder and the merchant, thus reducing the ability for an account holder to repudiate a transaction, and significantly reducing the fraud and charge-backs suffered frequently by merchants in the current traditional credit card purchase transaction (410).
12. Account holder verifies the time, transaction, transaction amount and the location. In the event that the merchant is a restaurant, the NBO also request the amount of tip to be added to the transaction. Once again the NBO will request that the account holder verify and pre-authorize the entire financial transaction amount with the tip now included (410).
13. Once the account holder has verified and pre-authorized all of the transaction parameters to the NBO, the NBO then checks money availability in the FAH account and allocates a sufficient enough sum to pay for the transaction. This is pre-authorization of the transaction by the account provider. Then, the NBO sends both the merchant and the account holder a one-time transaction clearance code, which is unique to that specific transaction, giving evidence to both parties that the financial transaction has been completed. This transaction clearance code is sent to the account holder within the transaction process, and also by, for example, SMS message it is also sent to the MBO for accounting purposes etc., for transfer by the MBO to the specific merchant location and POS, alerting the merchant that the financial transaction is in fact complete (411, 412).
14. Based upon how the merchant has established the account with the NBO, the merchant at the end of the business can use those transaction clearance codes to perform batch accounting in order to request that the NBO transfer all funds owed to the merchant by the NBO based upon the transaction clearance code. If the merchant does not have batch accounting capability, it can establish an immediate transfer of funds to the merchant account by the NBO upon completion of the transaction (106 in FIG. 1).

M-Commerce Data Flow When Customers Are On-the-Move

Initiating Gas Purchasing While Moving in a Car

FIG. 1 is transaction payment architecture equally applicable to e- and m-commerce. However, there are unique capabilities and features in the m-commerce architecture introduced in FIG. 1 that deserve to be reviewed separately. Indeed, the only communication channels in FIG. 1 where mobile devices can be used are Customer-NBO communication line (101 in FIG. 1) and Customer-MPOS communication line (104, 109, and 112 in FIG. 1). The use of mobile devices in FIG. 1 goes along with inter parties wired communication typically allocated to e-commerce, so that the overall picture is a mixture of e-commerce and m-commerce. Despite this fact we will call this case just m-commerce which is not at odds with a generally accepted view on m-commerce.

Advantages for m-commerce are two-fold. First, mobile phones are personalized communication devices in addition to being computer processing machines with general networking capabilities, unlike laptops and desktops. Practically, every adult has a mobile phone these days and can be reached instantly 24 hours a day. This is not true of laptops and desktops. Second, the payment architecture presented in FIG. 1 for m-commerce brings to the customers' camp all account holders on-the-move, first of all in a car, but also in a train, on a ship, at a vacation camp, hotel, and anywhere the customer is away from laptops or desktops enabling e-commerce.

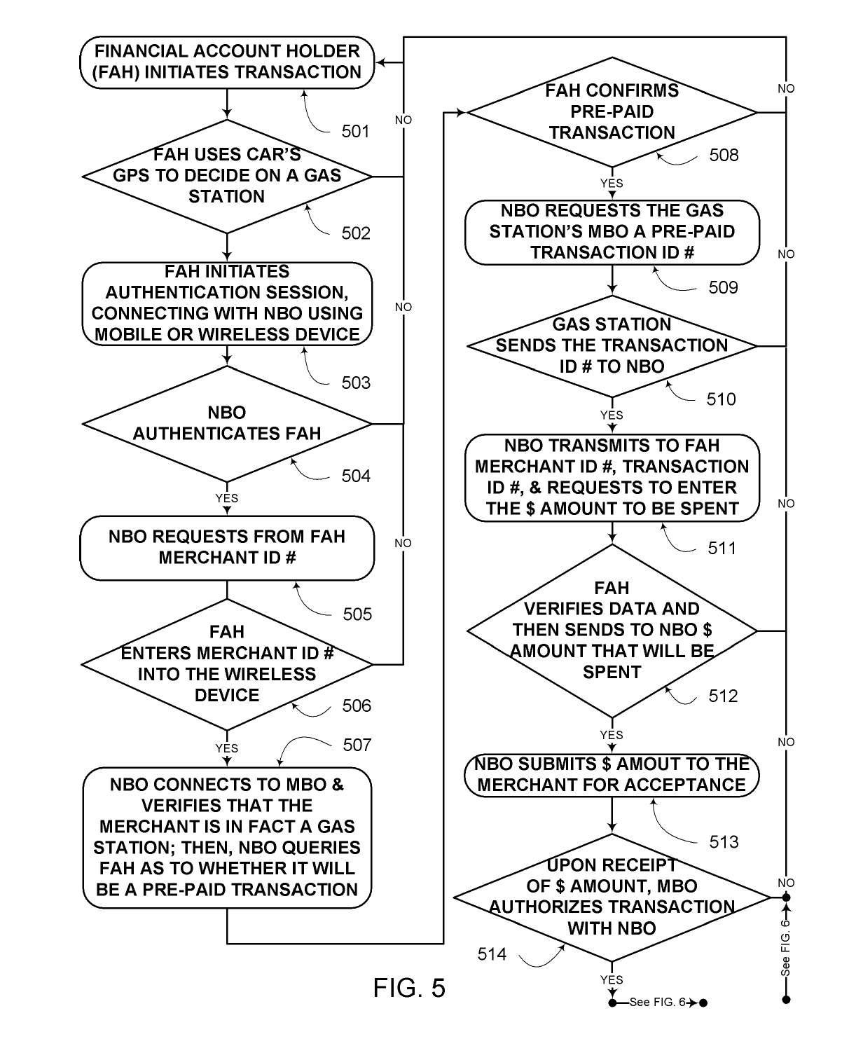

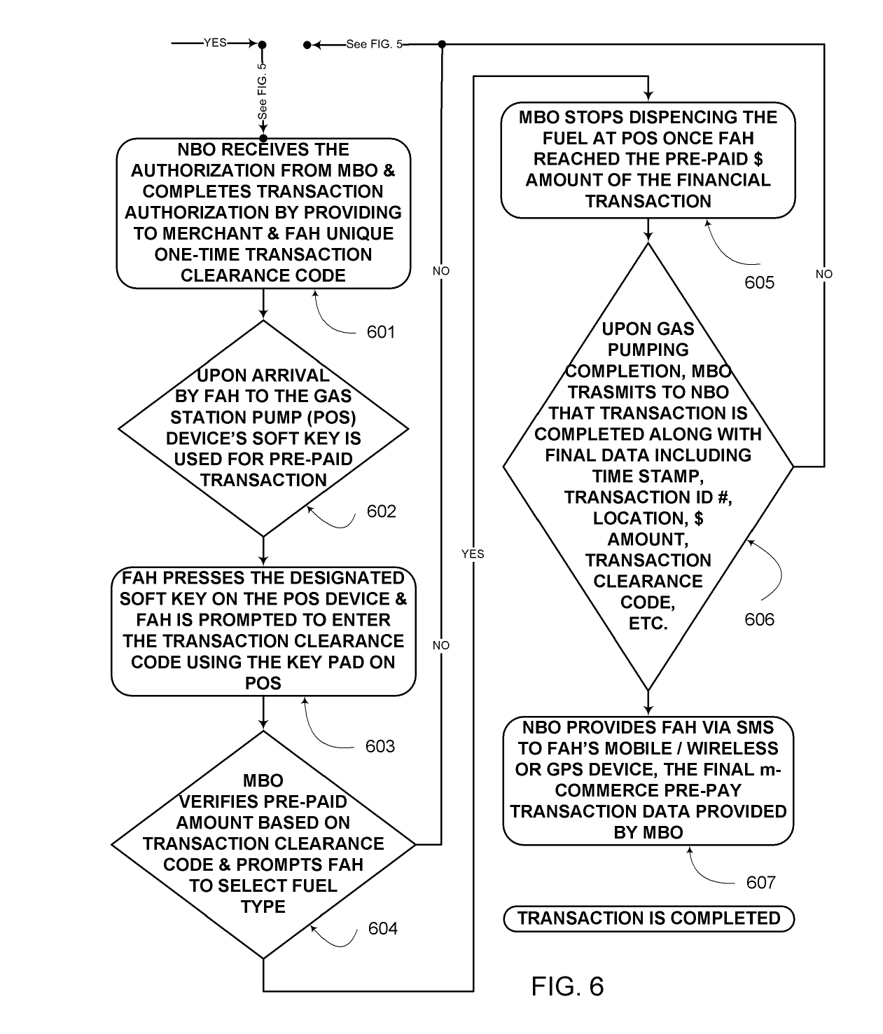

FIGS. 5 and 6 present a flow diagram of the multi-tier transaction processing method and payment system in m- and e-commerce when a customer is on-the-move during an online transaction (the preferred payment architecture embodiment of a customer in a car while processing a transaction with a gas station).

M-Commerce transactions can be used by immobile customers, that is online and offline customers according to the FIG. 4 data flow considered above for both, either e-commerce or m-commerce. In this subsection we will consider m-commerce financial transactions of the account holder not present in the merchant location. This adds a layer of complexity but is still within the embodiment of the invention. To give an explanation in a clear and concise manner we will use an example of a person driving in their car, who decides to purchase gas at a specific merchant gas station prior to arriving at the merchant gas station location.

Account holder utilizes their navigation system within their car, to locate the nearest merchant gas station.

Account holder may decide to purchase gas at this station upon arriving at the merchant gas station using the same m-commerce method as previously described for an immobile customer (see the previous subsection and FIG. 4). The account holder would give the station attendant or employee the amount of gas he wished to purchase and the merchant would provide the account holder with the merchant ID number, transaction ID number and the transaction would happen in the same manner as described above and depicted in FIG. 4.

However, in the event that the account holder wishes to purchase gas at the merchant location prior to arrival, or without the need to interact with the attendant or employee of merchant location much like using your credit card, ATM or debit card directly at the pump, which is commonly done today, another variation of the transaction is enabled within the embodiment of the invention as described below (see also FIGS. 5, 6) in which the NBO server acts to facilitate the definition of the transaction.
1. Account holder utilizes their navigation system within their car, to locate the nearest merchant gas station and makes a decision as to which merchant gas station they will perform an m-commerce financial transaction in order to purchase gas (502).
2. Account holder, using their mobile or wireless device, first participates in an authentication process with the NBO server to securely identify him/herself (503).
3. If authenticated (504), account holder then request an m-commerce transaction from the NBO server (50).
4. Account holder locates the merchant and enters the merchant ID number as provided by the GPS, or located on the gas pump (POS) device (not shown), and the NBO server requests from the account holder (505) and receives the merchant ID number.
5. The NBO server, based on use case parameters and data for example, determines that this merchant is in fact a gas station (506).
6. NBO server queries account holder if this m-commerce transaction will be a pre-pay transaction (507).
7. Account holder verifies that this will be a pre-pay transaction to NBO server (508).
8. NBO server utilizing the merchant ID number, requests from the gas station MBO server, a prepay transaction ID number (509).
9. Gas station MBO server upon receiving the request from NBO server for a prepay transaction ID number, sends the transaction ID number to the NBO server (510).
10. NBO server transmits within the m-commerce session to the account holder the merchant ID number, the transaction ID number, the location of the merchant, and requests the account holder to enter the financial amount the account holder would like to spend (511). Also, this in effect pre-authenticates the NBO server to the account holder.
11. Account holder verifies the location is correct, and enters the amount of money they would like to spend within this financial transaction at the merchant location, and transmits this data to the NBO server (512). This is in effect pre-authorization of the transaction by the account holder to the NBO.
12. NBO server upon receipt of the financial transaction amount from the account holder submits the financial amount to the MBO server for acceptance (513).
13. MBO server, upon receipt of the transaction amount, pre-authorizes the transaction with the NBO server (514). This also completes pre-authentication of the transaction by identifying and verifying the transaction parameters.
14. NBO server receives the authorization from MBO server and completes the financial transaction by executing an exchange of messages with a client account holding entity, allocating funds from the client account to the transaction, in effect pre-authorizing the transaction by the client account holding entity to the NBO, and provides both the merchant and the account holder with the unique, one-time, transaction clearance code for that prepay m-commerce financial transaction (601).
15. Upon arrival by the account holder to the merchant gas station, the account holder pulls up to the desired gas station pump (POS) device, and using the soft keys on the gas station pump (POS) device, presses the soft key that has been designated by the merchant gas station, as the m-commerce or prepay soft key (602).
16. Account holder presses the designated soft key on the gas station pump (POS) device, and the account holder is prompted by the gas station pump (POS) device to enter the unique one-time transaction clearance code, or part of it, using the key pad on the gas station pump (POS) device (603).
17. MBO server verifies the prepay amount based on the unique one-time transaction clearance code that is now stored within the MBO, prompts the account holder to select the grade of fuel and begin fueling (604).
18. MBO server or POS device stops dispensing of fuel at the gas station pump (POS) device once the account holder has reached the prepaid amount of the m-commerce financial transaction (605).
19. Upon completion of the account holder receiving the fuel, the MBO server transmits to the NBO server that the transaction has been completed, along with final transaction data, including but not limited to: time stamp, transaction ID number, location, amount of financial transaction, (perhaps grade of fuel and amount of fuel) and the one-time transaction clearance code (606).
20. NBO server provides the account holder via SMS to the account holders' mobile/wireless or GPS device, the final m-commerce prepay transaction data provided by the MBO server (607).

In the event that the account holder does not use the full amount of the prepayment that has been authorized, when the MBO server finalizes the transaction and submits the final financial transaction data of the unique transaction based on the transaction ID number to the NBO server, it will reflect the actual amount spent by the account holder, and the account holder will only be charged that amount. Such a difference would be reflected in the final m-commerce prepay transaction data provided by the MBO server to the NBO server, and further provided to the account holder by the NBO server.

Ordering Meal in a Fast Food Restaurant While Moving in a Car

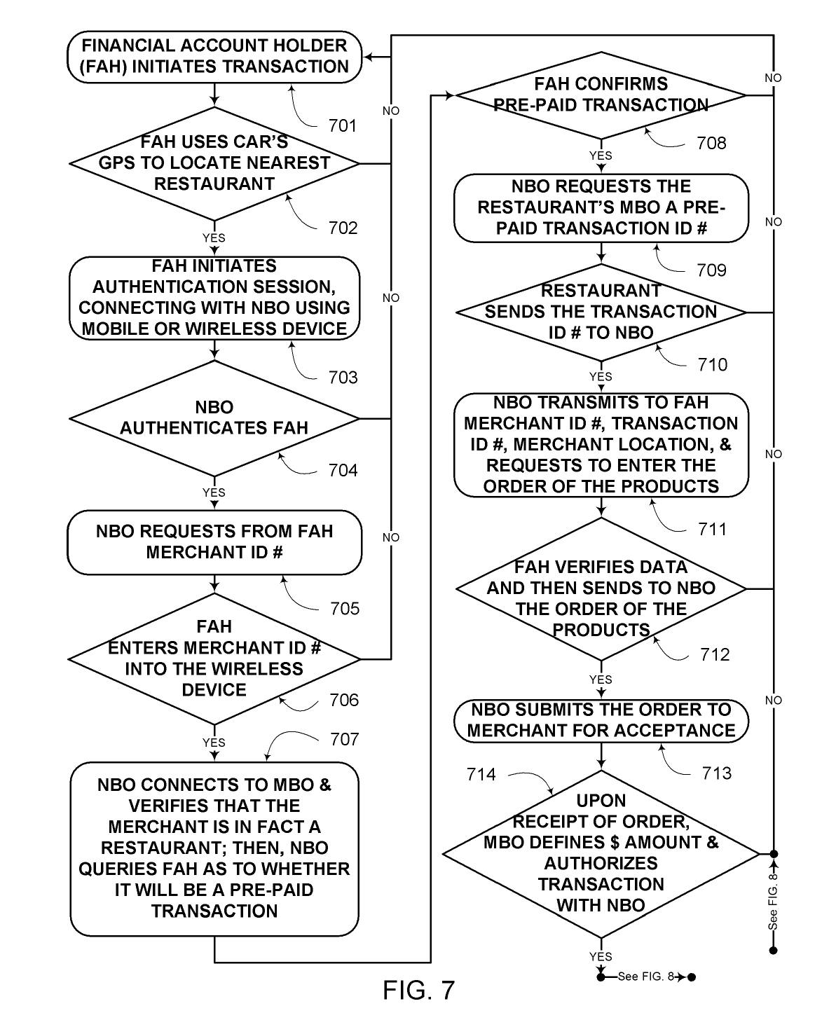

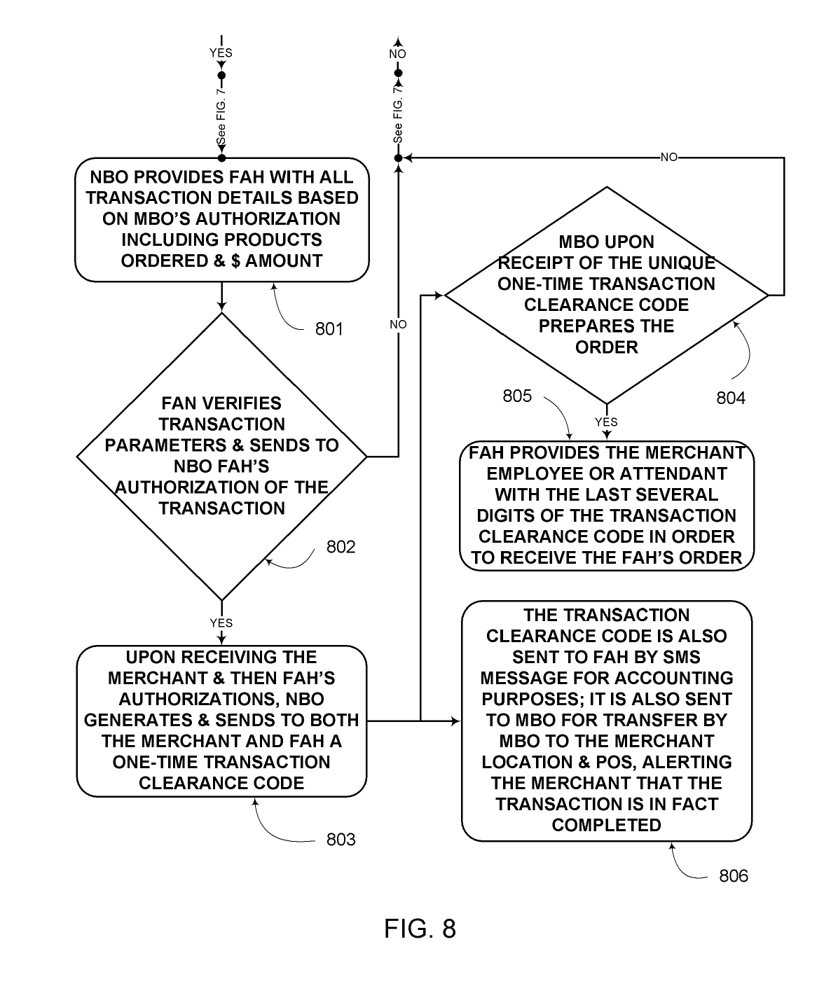

FIGS. 7 and 8 present a flow diagram of the multi-tier transaction processing method and payment system in m- and e-commerce when a customer is on-the-move during an online transaction (the preferred payment architecture embodiment of a customer in a car while processing a transaction with a fast food restaurant).

Further within the embodiment of the invention, this method would also be used in the case of a fast food restaurant for example. The entire m-commerce transaction would take place from the account holders' mobile/wireless/GPS device in very much the same manner, adding the step of the account holder ordering the desired food products, verifying the financial amount of the transaction, as described in the previous m-commerce transaction example. However, instead of entering the unique one-time transaction clearance code via soft keys at a merchant POS device as described above, the account holder would drive up to the fast food drive up window, and give the merchant employee or attendant the last 5 digits, for example, of the unique one-time transaction clearance code, in order to receive their order as set forth below.
1. Account holder initiates a transaction (701), and utilizes their navigation system within their car or on a mobile device, to locate the nearest merchant restaurant, and makes a decision as to which merchant restaurant they will perform an m-commerce financial transaction in order to purchase food products (702).
2. Account holder, using their mobile or wireless device, first initiates an authentication session (703) authenticates to the NBO server to securely identify him/herself (704).
3. NBO then requests a merchant ID from the Account holder (705).
4. Account holder enters the merchant ID as provided by the GPS, or provided by the NBO server via the mobile device (706).
5. NBO server receives the merchant ID and locates the merchant, NBO based on use case parameters and data, determines that this merchant is in fact a restaurant; and
6. NBO server queries account holder if this m-commerce transaction will be a pre-pay transaction (707).
7. Account holder verifies that this will be a pre-pay transaction to NBO server (708).
8. NBO utilizing the merchant ID, locates the MBO server and requests from the MBO server, a prepay transaction ID number (709).
9. MBO server upon receiving the request from NBO server for a prepay transaction ID number, sends the transaction ID number to the NBO server (710).
10. NBO server transmits within the m-commerce session to the account holder the merchant ID number, the transaction ID number, the location of the merchant, and requests the account holder to enter the order of the products the account holder wishes to purchase from the merchant (711). Also, this in effect pre-authenticates the NBO server to the account holder. The NBO server can facilitate the selection of products by presenting a catalog of goods, such as an on-line menu, to the account holder, by which the account holder selects the products.
11. Account holder verifies the location is correct, and enters the order of the products they wish to purchase from the merchant and transmits this data to the NBO server (712).
12. NBO server, upon receipt of the order of the products the account holder wishes to order, transmits this order data to the MBO server (713).
13. MBO server receives the order data, calculates the financial amount required to complete the transaction, and sends the entire financial transaction data back to the NBO server. MBO server provides the NBO server with the transaction details, time stamp, location, and financial amount of the purchase, and products ordered for final verification by the account holder (714). This communication is interpreted as pre-authorization of the transaction by the MBO server.
14. NBO provides the account holder with all of the financial transaction data provided by the MBO for verification including the product ordered and the final financial transaction amount and details (801).
15. Account holder is then required by the NBO server to verify the Merchant ID and specific location, time stamp, products ordered and the financial transaction amount (802). By having the NBO server submit to the account holder the financial transaction amount for specific verification by the account holder, it creates a non-repudiating event establishing pre-authorization of the transaction by the account holder, and completes pre-authentication of the transaction by identifying and verifying the parameters of the transaction. At this point, both the account holder and the merchant have pre-authorized the transaction, and the complete transaction has been pre-authenticated, thus reducing the ability for an account holder to repudiate a transaction, significantly reducing the fraud and charge-backs frequently suffered by merchants in the current traditional credit card purchase transaction.
16. Once the account holder has verified and authorized all of the transaction parameters to the NBO server, the NBO server then sends both the merchant and the account holder a one-time transaction clearance code, which is unique to that specific transaction, giving evidence to both parties that the financial transaction has been completed (803). This transaction clearance code is sent to the account holder within the transaction process, and also by SMS message for example, it is also sent to the MBO server to be used for accounting purposes etc., and for transfer by the MBO server to the specific merchant location and POS terminal, alerting the merchant that the financial transaction is in fact complete (806).
17. Upon receipt of the unique one-time transaction clearance code at the POS, the merchant prepares the order (804).
18. Account holder pulls up to the order window of the restaurant and provides the merchant employee or attendant with the last 5 digits (or whatever has been pre-decided as the number of digits required by the merchant) in order to receive the account holder's order (805).

Case of Small Merchants That Do Not Have a Back Office

Another type of m-commerce financial transaction is that whereby the merchant does not possess a POS device, terminal or back office by which the NBO can communicate. These may be smaller merchants who do not have the technological capabilities seen within large merchants, or individuals to whom the account holder wishes to transfer funds to directly utilizing the m-commerce mobile network.

In this case, the merchant or the individual must have a mobile device that has the ability to connect to the m-commerce network. Additionally, the merchant or individual must have an m-commerce account set up with the network operator, which designates how they will receive funds transferred to them via an m-commerce financial transaction from a different account holder. In this case the merchant ID number would be a person's m-commerce merchant ID number as assigned by the NBO server, and the transaction ID number would be assigned by the NBO server in the event that the individual or the smaller merchant does not have the ability to generate a transaction ID number.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. For automated transactions involving a first party and a second party agreeing to trade resources such as money in an account held by a third party on behalf of the first party for goods or services available from the second party, a method protecting personal identifying information of the first party from disclosure to the second party and protecting the specific transaction from repudiation by any party to the transaction, comprising:
executing a protocol using a server for obtaining commitments from the first, second and third parties to a specific transaction having transaction parameters arranged between the first and second parties, the protocol defining a pre-authenticated form of the specific transaction; obtaining authorization from the first and second parties for the server to commit on behalf of the first and second parties to the specific transaction in the pre-authenticated form; and obtaining authorization from the third party for the server to commit on behalf of the third party resources for clearance of the specific transaction in the pre-authenticated form;
after obtaining said authorizations from the first, second and third parties, generating at the server a transaction clearance code unique to the specific transaction, delivering the transaction clearance code to the parties of the specific transaction, and storing the transaction clearance code in the record of the specific transaction in the server;
said record of the specific transaction capable of being used for non-repudiation of the specific transaction by the first, second and third parties, and said transaction clearance code usable by the second party to prove a right to receive said allocated resources from the third party and by the first party to prove a right to receive the goods or services subject of the specific transaction from the second party.

2. The method of claim 1, wherein said defining a pre-authenticated form of the specific transaction includes:
exchanging messages on communication channels between the server and terminals of the first party and the second party (i) for authentication of the first party to the server by a user authentication process that identifies the first party and verifies that the first party holds an account with the third party, (ii) for identification and verification of the transaction parameters by receiving an identifier of the second party from the first party, by communicating with the second party for determination of the transaction parameters, and by communicating with the first party for verification of the transaction parameters, and (iii) for authentication of the server to the first party including delivering a transaction parameter determined by the server from the second party.

3. The method of claim 1, wherein said obtaining authorization from the first and second parties for the server to commit on behalf of the first and second parties to the specific transaction in the pre-authenticated form includes:
exchanging messages on communication channels between the server and terminals of the first party and the second party including communicating with the second party for indication of authorized transaction parameters, and by communicating with the first party for verification of the authorized transaction parameters.

4. The method of claim 1, including performing a process at the server to facilitate agreement of the transaction parameters for the specific transaction between the first and second parties.

5. The method of claim 1, wherein at least one of said communication terminals of the parties to the specific transaction comprises a mobile computing device executing a wireless communication protocol.

6. For automated transactions involving a first party and a second party agreeing to trade resources such as money in an account held by a third party on behalf of the first party for goods or services available from the second party, a method protecting personal identifying information of the first party from disclosure to the second party and protecting the specific transaction from repudiation by any party to the transaction, comprising:
executing a protocol using a server for obtaining commitments from the first, second and third parties to a specific transaction having transaction parameters arranged between the first and second parties, the protocol including:
exchanging messages on communication channels between the server and terminals of the first party and the second party (i) for authentication of the first party to the server by a user authentication process that identifies the first party and verifies that the first party holds an account with the third party, (ii) for identification and verification of the transaction parameters by receiving an identifier of the second party from the first party, by communicating with the second party for determination of the transaction parameters, and by communicating with the first party for verification of the transaction parameters, and (iii) for authentication of the server to the first party including delivering a transaction parameter determined by the server from the second party to thereby define a pre-authenticated form of the specific transaction;
storing a definition of the pre-authenticated form of the specific transaction in a record of the specific transaction in the server;
exchanging messages on communication channels between the server and terminals of the first party and the second party to obtain authorization from the first and second parties for the server to commit on behalf of the first and second parties to the specific transaction in the pre-authenticated form;
storing an indication in the record of the specific transaction in the server confirming said pre-authorization;
exchanging messages on communication channels between the server and terminals of the third party to obtain authorization from the third party for the server to commit on behalf of the third party resources for clearance of the specific transaction;
storing an indication in record of the specific transaction in the server confirming said authorization by the third party; and
after obtaining said authorizations from the first, second and third parties, generating at the server a transaction clearance code unique to the specific transaction, delivering the transaction clearance code to the parties of the specific transaction, and storing the transaction clearance code in the record of the specific transaction in the server;
said record of the specific transaction capable of being used for non-repudiation of the specific transaction by the first, second and third parties, and said transaction clearance code usable by the second party to prove a right to receive said allocated resources from the third party and by the first party to prove a right to receive the goods or services subject of the specific transaction from the second party.

7. The method of claim 6, wherein said protocol includes:
receiving a message from the first party including an identifier of the second party and a transaction identifier;
sending a message to the second party including the transaction identifier;
receiving a message from the second party including transaction parameters not received at the server from the first party, and indicating authorization by the second party for the server to commit to the specific transaction having the transaction parameters;
sending a message to the first party including transaction parameters received by the server from the second party, thereby authenticating the server to the first party; and
receiving a message from the first party indicating authorization by the first party for the server to commit to the specific transaction having the transaction parameters, whereby the specific transaction is pre-authenticated and authorized in its pre-authenticated form by the first and second parties.

8. The method of claim 6, wherein said protocol includes:
receiving a message from the first party including an identifier of the second party;
exchanging messages with the second party to verify the identifier of the second party;
receiving a message from the second party including a transaction identifier;
sending a message to the first party including the transaction identifier received by the server from the second party, thereby authenticating the server to the first party;
exchanging messages with the first party to determine transaction parameters, and indicating authorization by the first party for the server to commit to the specific transaction having the transaction parameters;
sending a message to the second party including the determined transaction parameters; and
receiving a message from the second party indicating authorization by the second party for the server to commit to the specific transaction having the transaction parameters, whereby the specific transaction is pre-authenticated and authorized in its pre-authenticated form by the first and second parties.

9. The method of claim 6, including performing a process at the server to facilitate agreement of the transaction parameters for the specific transaction between the first and second parties.

10. The method of claim 6, wherein said protocol includes
receiving a message from the first party including an identifier of the second party and an indication of a merchant type by communication from the first party;
exchanging messages with the second party to verify that the second party qualifies as said merchant type;
receiving a message from the second party including a transaction identifier for the specific transaction;
sending to the first party the transaction identifier;
exchanging messages with the first party to determine a selection of goods or services to produce an order for the second party;
sending the order to the second party; and
receiving a message from the second party indicating authorization by the second party for the server to commit to the specific transaction having transaction parameters satisfying the order, whereby the specific transaction is pre-authenticated and authorized in its pre-authenticated form by the first and second parties.

11. The method of claim 10, wherein said exchanging messages with the first party to determine a selection of goods or services to produce an order for the second party; includes:
presenting by the server a catalog of goods or services available for purchase from the second party, said catalog being accessible by the first party and including resources usable by the first party for selecting the goods or services for said transaction.

12. The method of claim 6, wherein at least one of said communication terminals of the parties to the specific transaction comprises a mobile computing device executing a wireless communication protocol.

13. A server for automated transactions involving a first party and a second party agreeing to trade resources such as money in an account held by a third party on behalf of the first party for goods or services available from the second party, while protecting personal identifying information of the first party from disclosure to the second party and protecting the specific transaction from repudiation by any party to the transaction, comprising:
a processor, a storage system coupled with the processor, and communication interfaces, and including instructions stored in the storage system and executable by the processor to execute a protocol including:
obtaining commitments from the first, second and third parties to a specific transaction having transaction parameters arranged between the first and second parties, the protocol defining a pre-authenticated form of the specific transaction, obtaining authorization from the first and second parties for the server to commit on behalf of the first and second parties to the specific transaction in the pre-authenticated form, and obtaining authorization from the third party for the server to commit on behalf of the third party resources for clearance of the specific transaction in the pre-authenticated form;
after obtaining said authorizations from the first, second and third parties, generating a transaction clearance code unique to the specific transaction, delivering the transaction clearance code to the parties of the specific transaction, and storing the transaction clearance code in the record of the specific transaction;
said record of the specific transaction capable of being used for non-repudiation of the specific transaction by the first, second and third parties, and said transaction clearance code usable by the second party to prove a right to receive said allocated resources from the third party and by the first party to prove a right to receive the goods or services subject of the specific transaction from the second party.

14. The server of claim 13, wherein said defining a pre-authenticated form of the specific transaction includes:
exchanging messages on communication channels between the server and terminals of the first party and the second party (i) for authentication of the first party to the protocol by a user authentication process that identifies the first party and verifies that the first party holds an account with the third party, (ii) for identification and verification of the transaction parameters by receiving an identifier of the second party from the first party, by communicating with the second party for determination of the transaction parameters, and by communicating with the first party for verification of the transaction parameters, and (iii) for authentication of the server to the first party including delivering a transaction parameter determined by the server from the second party.

15. The server of claim 13, wherein said obtaining authorization from the first and second parties for the server to commit on behalf of the first and second parties to the specific transaction in the pre-authenticated form includes:
exchanging messages on communication channels between the server and terminals of the first party and the second party including communicating with the second party for indication of authorized transaction parameters, and by communicating with the first party for verification of the authorized transaction parameters.

16. The server of claim 13, including instructions executable by the processor to facilitate agreement of the transaction parameters for the specific transaction between the first and second parties.

17. The server of claim 13, wherein at least one of said communication terminals of the parties to the specific transaction comprises a mobile computing device executing a wireless communication protocol.
